(19) United States
(12) Patent Application Publication
(10) Pub. No.: US 2008/0276730 A1
(43) Pub. Date: Nov. 13, 2008

(54) FLUID BED SAMPLING DEVICE

(75) Inventor: AARON K. BASTEN, SOLON, IA (US)

Correspondence Address: MCKEE, VOORHEES & SEASE, P.L.C., 801 GRAND AVENUE, SUITE 3200, DES MOINES, IA, 50309-2721, US

(73) Assignee: VECTOR CORPORATION, Marion, IA (US)

(21) Appl. No.: 11/746,754

(22) Filed: May 10, 2007

(51) Int. Cl. G01N 1/14; B01J 8/18

(52) U.S. Cl. 73/863.86; 137/561 R

(57) ABSTRACT

A sampling device for a fluid bed processor includes a body inserted into the wall of the container. A sample receiver is removably attached to the sampling body. The body has a passageway extending between the process container and the receiver. A vacuum source is applied to the passageway to draw a material sample from the container through the passageway for deposit into the receiver.

### BACKGROUND OF THE INVENTION

Fluid bed processors are typically used to process or treat particulate material, including very highly toxic or potent pharmaceutical compounds, for granulation, agglomeration, drying, powder coating, beading and/or tableting. During the processing, it may be desirable to obtain a product sample for interim testing to determine whether the process is proceeding as desired. Some of these materials, by their very nature, are hazardous to touch, inhale, or ingest. Therefore, it is very critical that the samples be obtained without exposing the operator. Typically, these hazardous or toxic samples are taken within an isolated enclosure, known as an isolator, or by an operator clothed in protective gear, including a respirator.

Isolators generally are bulky glove boxes, with a rapid transfer port that must be sealed to the process equipment. Alternatively, the process equipment can be entirely enclosed within the isolator. The isolator must be completely cleaned after each use, along with the equipment. The size of the isolator required to accommodate two gloves, one or more transfer ports, viewing windows, purged systems, and other components, necessarily limits the access of the operator to other aspects of the process equipment, such as gun ports, discharge ports, viewing windows, and other components, particularly when used on smaller development sized equipment.

Protective outfits are uncomfortable for an operator to wear for long periods of time. Also, if hazardous product contaminates the equipment room through the use of protective outfits, alone, the entire room must be decontaminated.

Therefore, there is a need for a compact, easy to use, safe sampling device that does not require an isolator on the equipment or extraordinary protective gear.

For other types of product materials which are not hazardous or toxic, such as certain powders, a sample device is slidably inserted through a port in the processor into the fluid bed to collect a sample into a cavity into the sampling device. The sampling device is then withdrawn from the product bed with the entrained sample. The sample is then deposited by gravity into another container by rotation of the sampling device. This type of sampling device requires seals that can accommodate both linear and rotational movement. Also, the sample product is disbursed throughout the sampling device by the linear and rotational movement, and may be mechanically forced through the seals, due to such movement.

Therefore, a primary objective of the present invention is the provision of an improved sampling device for a fluid bed processor.

Another objective of the present invention is the provision of an improved method of obtaining a product sample from a fluid bed processor.

Another objective of the present invention is the provision of a sampling device that plugs into a port in the wall of the processor and then remains fixed relative to the processor.

Still another objective of the present invention is the provision of a fluid bed sampling device having an air source for providing purged air to prevent a sample from being drawn into the device and providing a vacuum for drawing a sample into the device.

A further objective of the present invention is the provision of a sampling device removably mounted to a fluid bed processor having a sample receiver removably mounted to the sampling device.

Yet another objective of the present invention is the provision of an improved fluid bed processor with a sampling device which does not require an isolator or protective gear for the operator.

Another objective of the present invention is the provision of a fluid bed sampling device which is safe and easy to use, durable in use, and economical to manufacture.

These and other objectives will become apparent from the following description of the invention.

### BRIEF SUMMARY OF THE INVENTION

A sampling device is provided for a fluid bed processor having a container for treating particulate material. The device includes a body plugged into a port in a wall of the container, and fixed against sliding and rotational movement relative to the container. A sample receiver is removably mounted to the body. The body has a small diameter passageway and an enlarged chamber. The passageway has an inlet end communicating with the processor container and an outlet end communicating with the chamber. An air source is connected to the body and is reversible between positive and negative air flow. Normally, positive pressure air flow is provided to purge the passageway and prevent particulate material from entering the passageway. When a sample is desired, the air source is reversed to create a vacuum to draw a product sample from the fluidized bed into the passageway. As the product sample exits the outlet end of the passageway, the enlarged chamber of the body causes the product velocity to drop, such that the sample product is deposited into the sample receiver. The vacuum can then be deactivated, so as to stop the withdrawal of product from the fluidized bed. The sample receiver can be removed from the body for inspection of the product sample.

### BRIEF DESCRIPTION OF THE DRAWINGS

FIG. 1 is a side elevation view of the container of a fluidized bed processor, having the sampling device of the present invention mounted thereon.

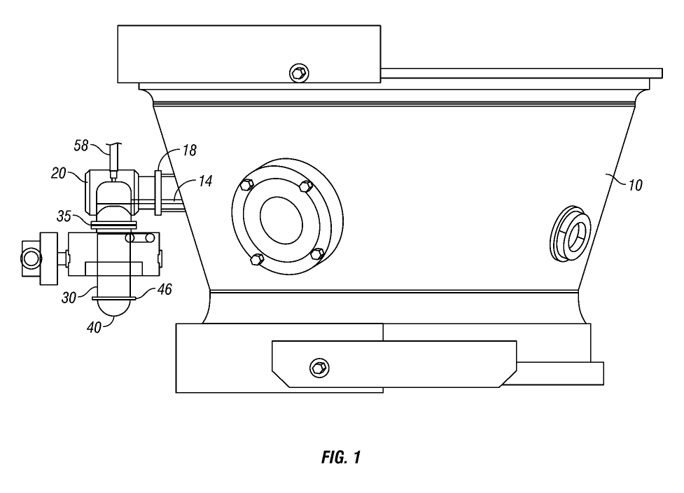

FIG. 2 is another side elevation view of the container with the sampling device mounted thereon.

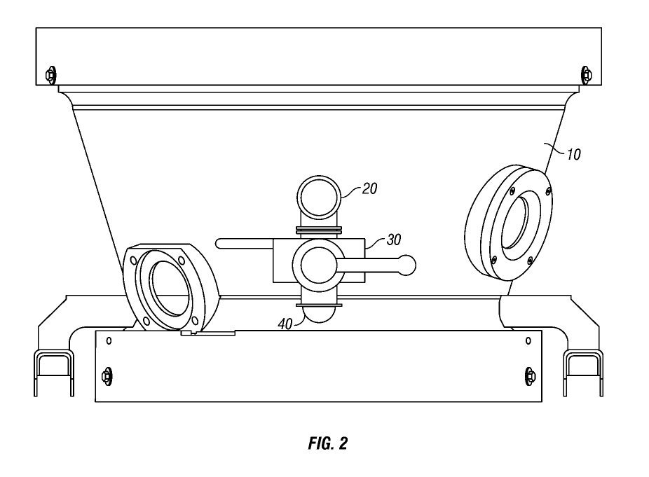

FIG. 3 is a top plan view of the container with the sampling device mounted thereon.

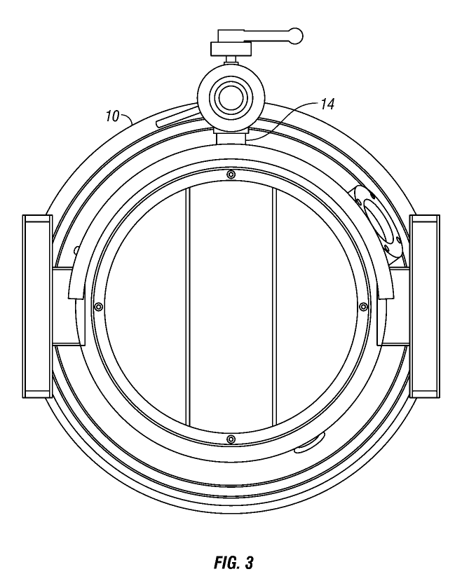

FIG. 4 is a sectional view of the container wall, port, and sampling device.

### DETAILED DESCRIPTION OF THE PREFERRED EMBODIMENT

A product container for a fluidized bed processor is generally designated in the drawings by the reference numeral 10. It is understood that the processor and container can take various forms, beyond that shown in the drawings. The container 10 includes a wall 12 with a port 14 in a form of a tubular sleeve or collar.

The sampling device of the present invention is generally designated by the reference numeral 20. The sampling device 20 includes a body 22 adapted to be plugged into the port 14. The inner end of the body 22 includes a circumferential groove 24 with an O-ring 26 to provide a seal between the body 22 and the port 14. The body 22 includes a perimeter flange 28 which matingly engages with the flange 16 of the container 10. A clamp 18 is adapted to engage the flanges 16, 28 so as to retain the sampling device 20 in a fixed position relative to the port 14. An O-ring or other seal 29 may be provided between the flanges 16, 28.

A sample container or receiver 30 is removably mounted to the sampling device 20 in any convenient manner. For example, as shown in the drawings, the body or plug 22 includes a downwardly extending tube 32 with a perimeter flange 34 adapted to matingly engage a flange 36 on the upper end of the receiver 30. A clamp 35 may hold the flanges 34, 36 together, while allowing removal of the sample receiver 30 from the sampling device 20. A seal 37 may be provided between the flanges 34, 36.

As seen in the drawings, the receiver 30 includes a body 38 and a removable bag or container 40 for holding the sample product. Flanges 42, 44 may be provided on the body 38 and bag 40, respectively, with a clamp 46 securing the flanges 42, 44 together such that the bag 40 is removably mounted to the body 38. A seal 48 may be provided between the flanges 42, 44. It is understood that the sample receiver 30 may take various forms, all of which may be provided with an air tight seal to the sampling device 20. For example, the receiver 30 may be a bottle, an isolation valve, a continuous sleeve, or other container.

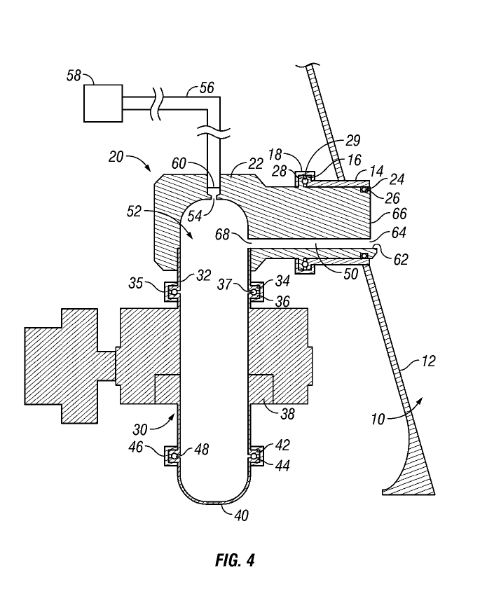

The body 22 of the sampling device 20 includes a relatively small-diameter passageway 50 and an enlarged chamber 52, as seen in FIG. 4. The cross-sectional area of the passageway 50 is much smaller than the cross-sectional area of the chamber 52. The body 22 also includes a hole or aperture 54 to which an air line 56 is attached in any convenient manner, such as by mating threads or a quick connect coupler. The air line 56 is connected to an air supply 58, such as a reversible pump, so as to alternatively provide purge air and a vacuum. The purge air and vacuum may be provided by the single means 58 or by separate means.

A filter 60 is preferably provided between the sampling device 20 and the air supply 58, such as in the aperture 54. The filter 60 preferably has at least a micron size rating, and most preferably will have a sub-micron rating so as to limit the possibility of fine powder passing therethrough to the air supply 58 when in the vacuum mode. The filter may be disposable, or cleanable and reusable.

While the drawings show a preferred embodiment of this sampling device of the present invention, it is understood that the device may take other forms without departing from the scope of the invention. Generally, the sampling device 20 is a simple body plug 22 which is inserted into the fluid bed product container 10 through a sanitary ferrule or other style port 14 using a static seal or combination of seals. The insertion port 14 may be horizontal, as shown in the drawings, or may be normal to the product container wall 12 or an angle to the container wall 12. The seals may be sanitary gaskets commonly associated with “Tri-Clamp” ferrules, flat gaskets, bow-rings, or the like, and may be made of various material compositions. The sampling device 20 may be clamped in place with quick release clamps or other fasteners, such as screws, hand knobs, toggle clamps, and the like.

The sampling device 20 may be made of a variety of materials, including plastic or metal, and preferably of a sanitary FDA approved component nature, such as 316 grade stainless steel. Other materials may prove advantageous due to costs, corrosion resistance, or material compatibility issues.

The end of the sampling device 20 inserted into the port 14 may or may not be flush with the inside surface of the container wall 12. As seen in FIG. 4, the body 22 includes a small, expended shelf 62 which momentarily blocks or retards the flow of particulate material to be sampled as the material passes the sample passageway 50, as described below. The sample aperture 54 is relatively small in diameter, and preferably extends axially with respect to the longitudinal axis of the plug body 22, with the inlet end 64 of the aperture 50 being perpendicular to the end face 66 of the plug body 22. The passage 50 is preferably below the horizontal center line of the body 22, and tangent to the top side of the shelf 62. However, it is understood that the passageway 50 may extend in different orientations, without being axial to the body 22, without being normal to the end face 66, without being tangent to the top side of the shelf 64, and without being below the horizontal center line of the body 22. For example, the passageway 50 may be centered on the longitudinal axis of the body 22. The size of the passageway 50 depends upon the material being sampled, and is large enough to permit passage of powder, beads, or tablets therethrough.

The outlet end 68 of the passageway 50 intersects with the cavity or chamber 52 in the body 22. The lower end of the chamber 52 is open so as to communicate with the sample receiver 30. It is understood that for non-toxic and non-hazardous materials, the chamber 52 can be opened to the atmosphere for depositing the sample into a open receiver which is not connected to the sampling device 20.

Examples of valves which may be used include a butterfly, a split butterfly, a ball, a pinch, or other type. These various types of receivers may also be used in combinations with one another.

### Basic Operating Principle

When the fluid bed processor is operating, the internal chamber is normally at a slightly negative pressure. During this normal operation of the processor, the air supply 58 is activated to supply air into the sampling device 20, thereby purging the filter 60 and the passageway 50. This positive air flow may be due to the differential pressure drop from a port opened to the atmosphere and the negative pressure of the fluid bed chamber, or maybe from a pressurized air source such as an air compressor system or pressurized air vessel such as, but not limited to, a pressurized nitrogen tank. In either instance, the purged air pressure is limited such that the sampling device 20 cannot be positively pressurized while the fluid bed processor is operating. The sampling device 20 is normally not activated when the fluid bed processor 10 is not operating.

When it is desired to obtain a sample of product material from the container 10 of the processor, the purge air is shut off and a vacuum source is connected to the aperture 54 of the sampling device 20. For example, the pump 58 can be reversed from purge air to vacuum using a control system. The vacuum must necessarily be a lower pressure than that of the processor container 10 so as to provide an air flow into the passageway 50 from the container 10. The air flow through the passageway 50 must also be of a sufficient volume so as to provide transport velocity for the product material being sampled. Thus, the material is drawn into the inlet end 64 of the passageway 50 from the container 10. As the product passes through the passageway 50 and exits the outlet end 68, the increased area of the chamber 52 causes the product velocity to decrease such that the product falls out of the air stream and into the receiver 30. When a sufficient sample size is obtained, the vacuum source is turned off. The purge air may again be activated so as to clean the passageway 50, though such cleaning is not required at this time.

The product sample is now contained in the receiver 30 and/or bag 40, which can be removed from the sampling device 20 via the clamp 35 or the clamp 46.

Additional apertures may be provided in the body 22 for flushing with cleaning solutions, if desired. Water or other cleaning solution may be used to clean the sampling device 10. If toxic or hazardous product samples have been obtained, the cleaning liquid preferably wets all surfaces of the sampling device 20 and receiver 30. The wash water or solution can then be removed to ensure that any retained product can be rendered dust free and allow the device 20 and its ancillary equipment to be removed for further cleaning by properly protected personnel.

It is understood that a system of valves and timers may be incorporated with the sampling device 20 so as to activate the purge air and vacuum source 58, and cleaning solution. There may also be circuitry for opening and closing isolation valves, if desired. These valves, timers and other controls may be housed in a free standing control box, integrated into the fluid bed control system, or a combination of both. Preferably, the timing system should be capable of fractions of a second accuracy, and preferably be programmable by an operator or service personnel, or menu driven for use with different product types. The purge air and vacuum valves, transducers, pumps, and other components preferably are isolated from contact with any cleaning solution.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A fluid bed processor for processing particulate material, comprising:
a container for processing the material in a fluid bed formed in the container;
a port fixed in the container;
a body mounted in the port so as to be in a fixed position, and having a chamber and a passageway with a first end communicating with the fluid bed and with a second end communicating with the chamber;
means connected to the body to selectively provide positive and negative pressure to the passageway;
a material receiver connected to the body and in communication with the chamber;
wherein the means provides purge air through the passageway to preclude material from being drawn into the passageway from the fluid bed; and
wherein the means provides a vacuum to the passageway to draw material from the fluid bed through the passageway and into the chamber for deposit into the receiver.

2. The fluid bed processor of claim 1 further comprising a filter between the chamber and the means.

3. The fluid bed processor of claim 1 wherein the body includes a shelf residing within the container.

4. The fluid bed processor of claim 1 wherein the body is removably mounted to the container.

5. The fluid bed processor of claim 1 wherein the material receiver is removable mounted to the body.

6. The fluid bed processor of claim 1 wherein the chamber has a larger cross-sectional area than the passageway.

7. A sampling device for a fluid bed processor having a container for treating particulate material, the device comprising:
a body plugged into a wall of the container and fixed against sliding movement relative to the container;
a sample receiver removably attached to the body;
the body having a passageway with inlet and outlet ends providing communication between the container and the receiver; and
a vacuum source for applying a vacuum to the body to thereby draw a material sample from the container through the passageway for deposit into the receiver.

8. The sampling device of claim 7 wherein the body includes an enlarged chamber at the outlet end of the passageway.

9. The sampling device of claim 7 wherein the vacuum source is reversible so as to supply a positive air flow through the passageway and into the container to prevent material from entering the passageway from the container.

10. The sampling device of claim 7 further comprising a filter in the body to preclude material from flowing to the vacuum source.

11. The sampling device of claim 7 wherein the inlet end of the passageway includes a shelf residing within the container.

12. A method of obtaining a product sample from a fluidized bed processor, comprising:
installing a body into a port in the processor so as to be fixed against sliding and rotational movement;
applying a vacuum to a passageway in the body communicating with the processor so as to draw a product sample from the fluidized bed into the passageway;
depositing the product sample into a receiver connected to the body without moving the body; and
removing the receiver from the body.

13. The method of claim 12 further comprising applying purge air through the passageway and into the processor so as to maintain a clean passageway when a product sample is not being drawn.

14. The method of claim 12 further comprising maintaining the body in a fixed position relative to the processor port whether or not a sample is being obtained.

15. The method of claim 12 further comprising reducing velocity of the product sample upon exiting the passageway such that the product sample drops into the receiver.

16. The method of claim 12 wherein the sample is obtained without an isolator.

17. The method of claim 12 wherein the sample is obtained without protective gear.
